(19) United States
(12) Patent Application Publication
(10) Pub. No.: US 2020/0033884 A1
(43) Pub. Date: Jan. 30, 2020

(54) METHOD FOR CONTROLLING A DOCKER IN AUTONOMOUS DRIVING SYSTEM AND APPARATUS FOR THE SAME

(71) Applicant: LG ELECTRONICS INC., Seoul (KR)

(72) Inventor: Soryoung KIM, Seoul (KR)

(73) Assignee: LG ELECTRONICS INC., Seoul (KR)

(21) Appl. No.: 16/593,734

(22) Filed: Oct. 4, 2019

(30) Foreign Application Priority Data
Aug. 30, 2019 (KR) 10-2019-0107798

(51) Int. Cl. G05D 1/02; G05D 1/00; B62D 63/02; G06Q 10/02; G06Q 50/30; H04W 4/40

(52) U.S. Cl. CPC G05D 1/0287; G05D 1/0088; B62D 63/02; G05D 2201/0212; G06Q 50/30; H04W 4/40; G06Q 10/02

(57) ABSTRACT

A method for controlling a docker in an autonomous driving system and an apparatus for the same are provided. When a vehicle call message requesting a docker is received from a passenger device, a vehicle is selected based a call location of the passenger and a docker request message is transmitted to a docker platform in response to the vehicle call message. When an available docker list is received from the docker platform, a specific docker among the dockers included in the docker list is selected and a docker call message requesting a provision of a docker service is transmitted to the selected docker. Control method providing in autonomous driving system of the present disclosure can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATIONS

Pursuant to 35 U.S.C. § 119(a), this application claims the benefit of earlier filing date and right of priority to Korean Patent Application No. 10-2019-0107798, filed on Aug. 30, 2019, the contents of which are hereby incorporated by reference herein in its entirety.

### BACKGROUND OF THE INVENTION

### Field of the Invention

The present disclosure relates to a method for controlling a docker in an autonomous driving system and an apparatus for the same, and particularly, to a method and an apparatus for providing a baggage docking service of an autonomous vehicle.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

In an autonomous driving system, when baggage of the passenger using the autonomous vehicle is large, limitation in an interior space of the vehicle may cause inconvenience to the passenger and may also cause problems for safety of the passenger.

### SUMMARY OF THE INVENTION

The present disclosure aims to achieve the above-described needs and/or to solve the above-described problems.

The present disclosure provides a docking service providing method according to whether or not to use baggage for a user (passenger) who uses an autonomous vehicle.

The present disclosure also provides a method of searching for a docker connectable according to a docker provision request and providing various function/size options according to a type of the baggage.

The present disclosure also provides a method for changing drive setting of an autonomous vehicle after the autonomous vehicle and the docker are connected to each other.

The present disclosure also provides a method for inferring a baggage state and providing baggage information based on internal/external monitoring information of the docker.

In an aspect, a method of controlling a docker in an autonomous driving system is provided. The method includes receiving a vehicle call message including information on whether or not there is a docker request from a device of a passenger, selecting a vehicle based on first information indicating a call location of the passenger, transmitting a docker request message including at least one of the first information, second information indicating a location of the vehicle, and third information indicating a drive path of the vehicle to a docker platform in response to the vehicle call message, receiving a docker response message including an available docker list from the docker platform, selecting a specific docker among the dockers included in the docker list, and transmitting a docker call message requesting a provision of a docking service for the vehicle to the selected docker.

The selecting of the vehicle may select the vehicle based on information indicating whether or not communication with the docker is possible, information indicating whether or not a physical connection to the docker is possible, information on a distance between the call location and the vehicle, and vehicle allocation state information of the vehicle.

The transmitting of the docker request message to the docker platform may include selecting the docker platform based on the first information and docker request information of the passenger, and transmitting the docker request message to the selected docker platform.

The docker list information may include information on at least one docker available in the docker platform, and the information on the docker includes at least one of charging state information of the docker, size information of the docker, and monitoring device information provided in the docker.

The docker call message may include authentication information on the vehicle, and when the selected docker approaches within a specific distance range based on the call location, the authentication between the vehicle and the docker may be performed based on the authentication information on the vehicle.

The selected docker may provide monitoring information on an inside of the selected docker and/or monitoring information on an outside of the selected docker to the vehicle.

The method may further include a drive setting value of the vehicle based on size information of the selected docker.

The changing of the drive setting value of the vehicle may be performed by changing a vehicle interval setting value and other vehicle overtaking speed setting value based on the size information of the selected docker.

In another aspect, an apparatus for controlling a docker in an autonomous driving system is provided. The apparatus includes a processor configured to control a function of own vehicle; a memory configured to be coupled to the processor and to store data for controlling the vehicle; and a transceiver configured to be coupled to the processor and to transmit or receive data for controlling the vehicle, in which the processor receives a vehicle call message including information on whether or not there is a docker request from a device of a passenger, selects first information indicating a call location of the passenger, transmits a docker request message including at least one of the first information, second information indicating a location of the vehicle, and third information indicating a drive path of the vehicle to a docker platform in response to the vehicle call message, receives a docker response message including an available docker list from the docker platform, selects a specific docker among the dockers included in the docker list, and transmits a docker call message requesting a provision of a docking service for the vehicle to the selected docker.

### BRIEF DESCRIPTION OF THE DRAWINGS

Accompanying drawings included as a part of the detailed description for helping understand the present invention provide embodiments of the present invention and are provided to describe technical features of the present invention with the detailed description.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram illustrating the interior of a vehicle according to an embodiment of the present invention.

FIG. 10 is a block diagram referred to in description of a cabin system for a vehicle according to an embodiment of the present invention.

FIG. 11 is a diagram referred to in description of a usage scenario of a user according to an embodiment of the present invention.

FIG. 12 is a simplified diagram of an autonomous driving system according to an embodiment of the present disclosure.

FIG. 13 shows an example of a block diagram of an autonomous driving system according to an embodiment of the present disclosure.

FIG. 14 shows an example of a block diagram of an autonomous driving system according to an embodiment of the present disclosure.

FIG. 15 is a signal flowchart showing an example of a docker call method according to an embodiment to which the present disclosure is applied.

FIG. 16 is a signal flowchart showing an example of a connection method between a vehicle and a docker according to an embodiment to which the present disclosure is applied.

FIG. 17 is a flowchart showing an example of a docker call method according to an embodiment of the present disclosure.

FIG. 18 is a signal flowchart showing an example of a connection method between an autonomous vehicle and a docker according to an embodiment of the present disclosure.

FIG. 19 is a flowchart showing an example of a method for controlling a vehicle in an autonomous driving system according to an embodiment of the present disclosure.

The accompanying drawings, which are included as a part of detailed descriptions to aid understanding of the present disclosure, provide an embodiment of the present disclosure and, together with the detailed description, explain technical features of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

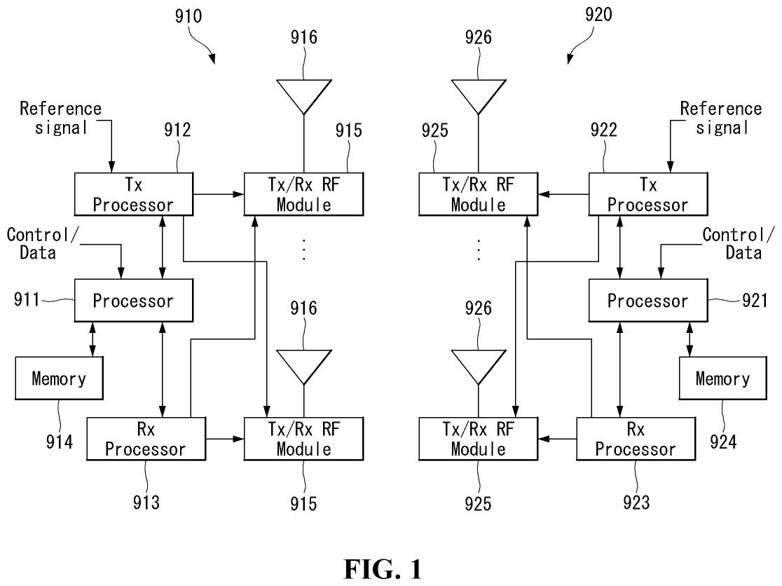

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

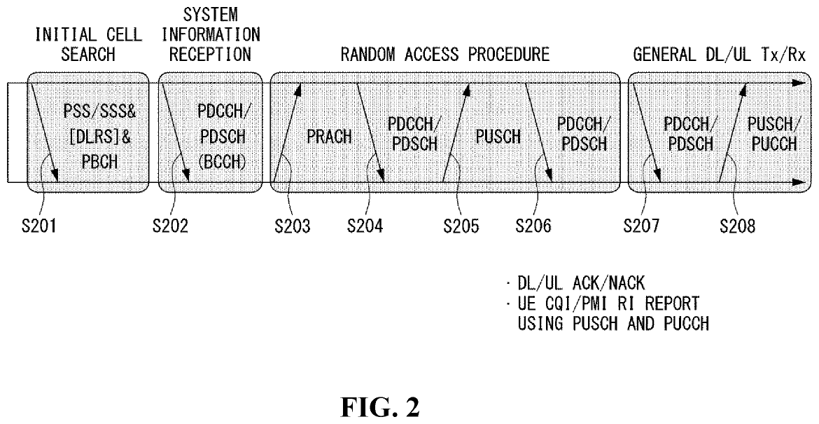

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the OSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ssb-Index-RSRP′, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

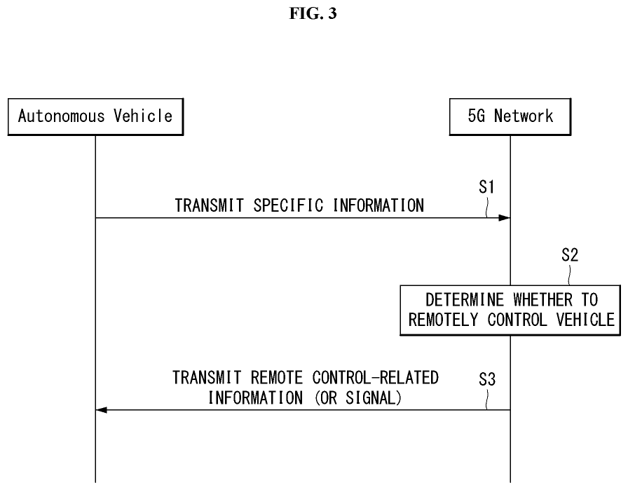

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

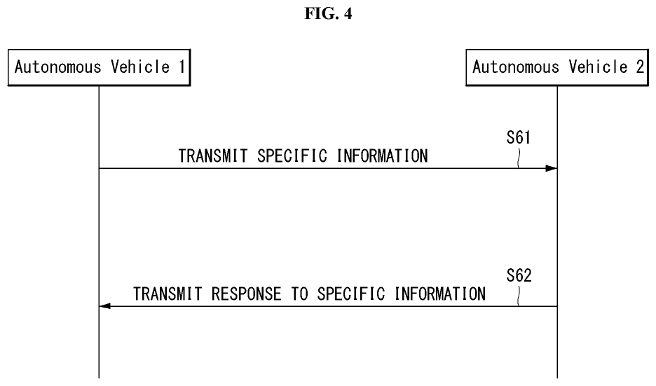

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

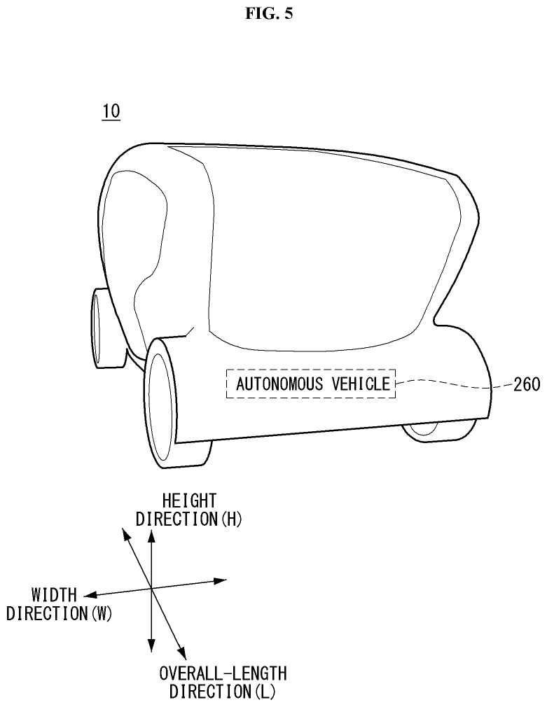

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

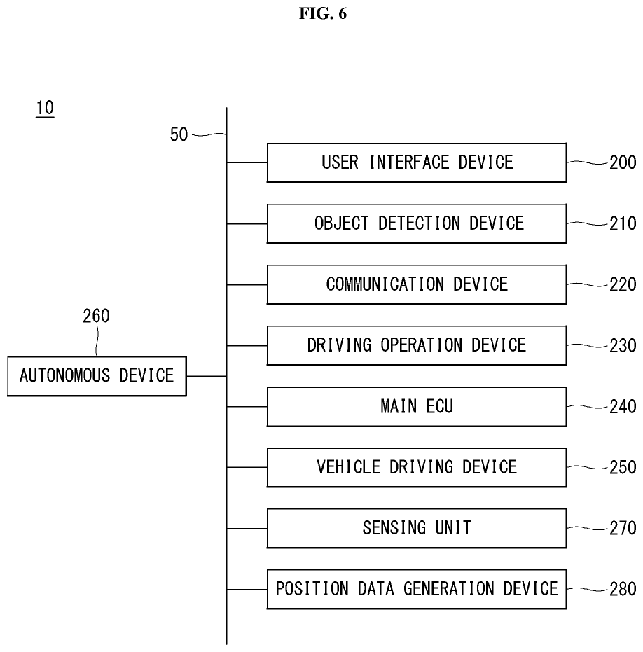

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals.

The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

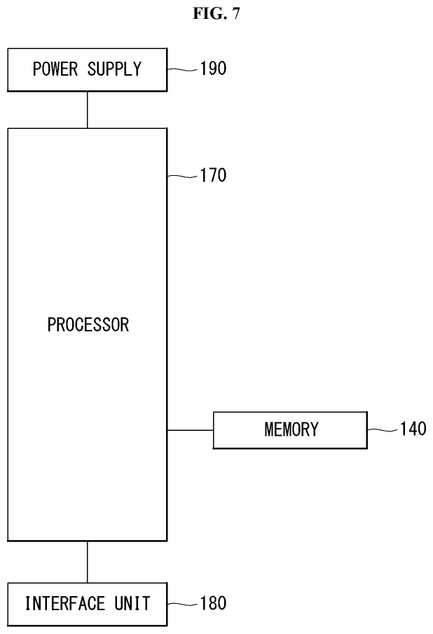

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

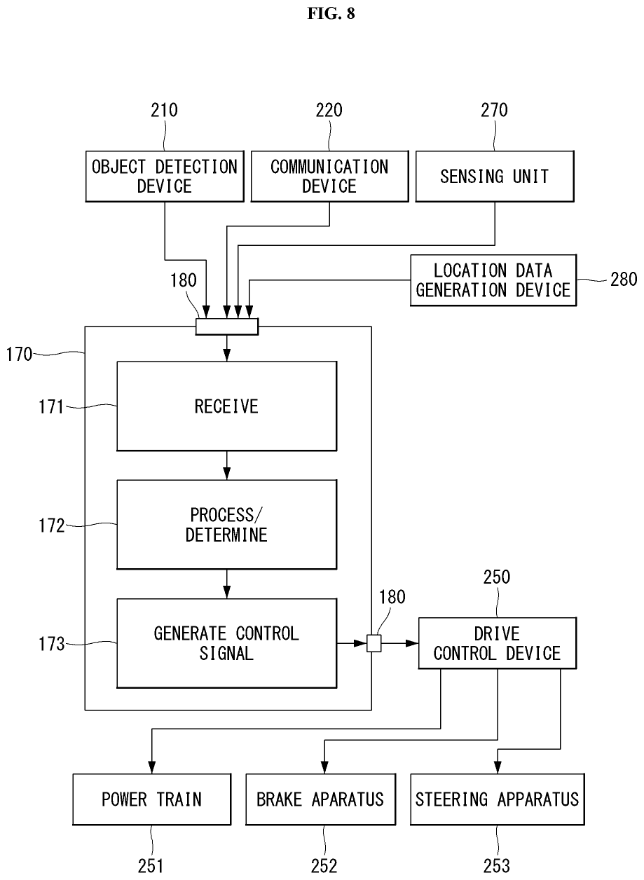

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

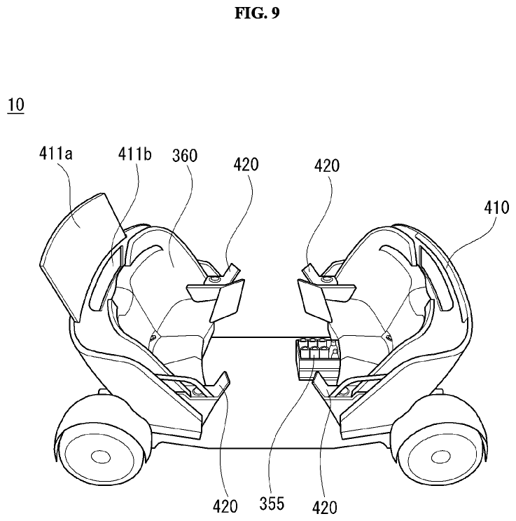

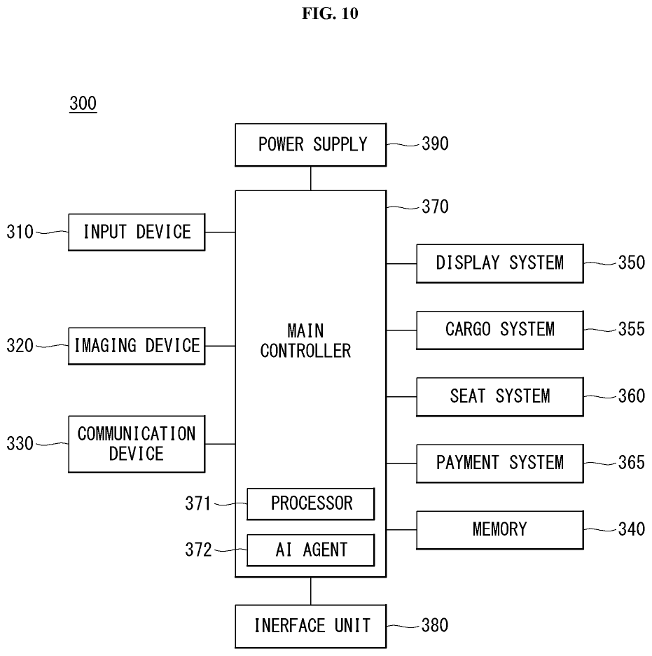

FIG. 9 is a diagram showing the interior of the vehicle according to an embodiment of the present invention. FIG. 10 is a block diagram referred to in description of a cabin system for a vehicle according to an embodiment of the present invention.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

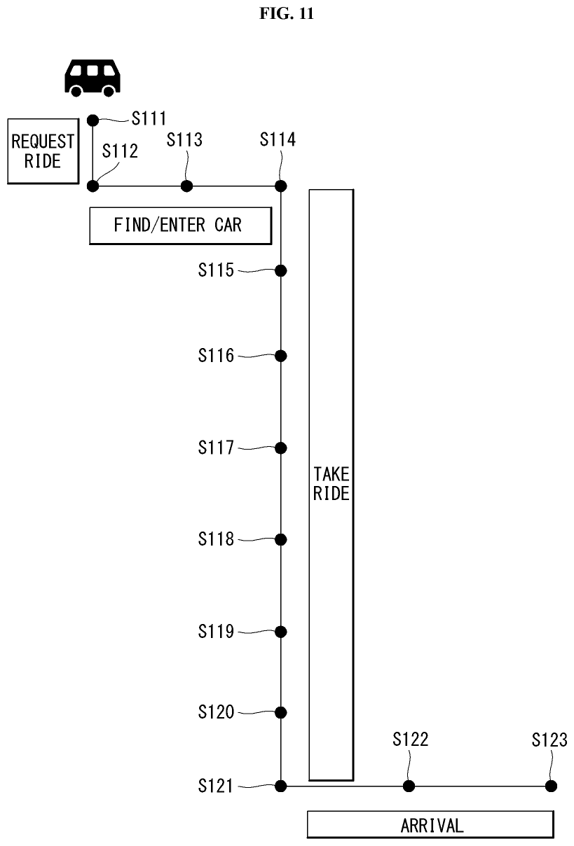

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present invention which will be described later and applied or can complement the methods proposed in the present invention to make technical features of the present invention concrete and clear.

In general, when the baggage of the passenger is large in an autonomous vehicle or when the baggage occurs due to a specific behavior during riding, comfort during the riding may be reduced due to the limitation of an internal space of the vehicle.

In addition, an area of a passenger may be invaded by the baggage of other persons in an autonomous drive-based shared vehicle. Moreover, an increase or decrease of a baggage space is required according to size/type of the baggage. However, there is a limitation in predicting/providing the space in the autonomous vehicle. The size/type of the baggage may vary widely, and thus, elements to be considered when the driving may be added.

For example, when a trailer is connected to a rear portion of the vehicle, not only is it difficult to appropriately monitor inner baggage, but also there is a problem that the trailer should always be carried in any case. In addition, when the baggage is loaded on a vehicle in the form of a tow, there is a disadvantage that the vehicle must be stopped unconditionally to check a state of the baggage during the driving.

Accordingly, in order to solve the above-described problems, the present disclosure proposes a method for changing a drive mode (or drive setting) of the autonomous vehicle when a docker capable of being docked to the autonomous vehicle and the vehicle are connected to each other in order to load the baggage of the passenger.

The passenger is the user who uses the autonomous vehicle. However, in the present disclosure, the passenger may refer to a device (for example, terminal) of the passenger. That is, in the present specification, the passenger may indicate the passenger device, the passenger terminal, a user device, a user terminal, or the like. In this case, a specific behavior or a specific operation of the passenger may be an operation by the device or the terminal. For example, a behavior in which a passenger requests the autonomous vehicle for the server indicates an operation in which the terminal of the passenger transmits a request message (or data) requesting the autonomous vehicle to the server.

In an embodiment of the present disclosure, the docker capable of loading the baggage of a passenger may be a (ultra) lightweight autonomous driving robot. The passenger may request a docking service provision by calling the docker when the baggage occurs during (or before) the driving.

In addition, in an embodiment of the present disclosure, when there is a docker request, the server managing the autonomous driving system may search for a connectable docker. The server proposes a method for providing various function/size options according to a type of baggage.

In addition, in an embodiment of the present disclosure, the drive setting of the vehicle may be changed when the autonomous vehicle and the docker are coupled to each other. In an embodiment, the vehicle proposes a method for performing a drive negotiation with another vehicle by including docker information during the driving.

Moreover, in an embodiment of the present disclosure, a method for interring the baggage state based on internal/external monitoring information of the docker and providing the baggage information is proposed.

According to the embodiment of the present disclosure, it is possible to an optimum comfort to all passengers present in the vehicle by providing the docking service, and thus, to increase a drive satisfaction. In addition, it is possible to secure safety of the baggage to be transported.

Moreover, according to an embodiment of the present disclosure, a user convenience may be improved by calling a docker nearest to a baggage generation point of the passenger.

In addition, according to an embodiment of the present disclosure, it is possible to provide information satisfaction to the passenger through baggage state monitoring.

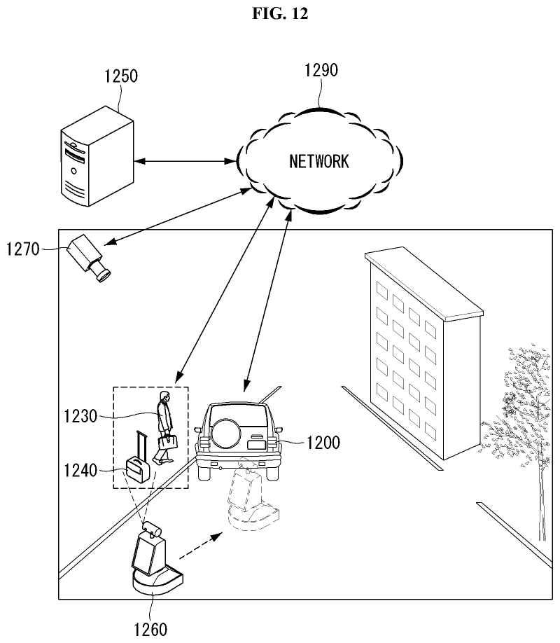

FIG. 12 is a simplified diagram of the autonomous driving system according to an embodiment of the present disclosure.

Referring to FIG. 12, the autonomous driving system may include a vehicle (or own vehicle, current vehicle) 1200 controlled according to an embodiment of the present disclosure, a server 1250 which manages/provides drive data while communicating with the vehicle 1200, a docker 1260 which provides a docking service while communicating with the server 1250, a management camera 1270, and a passenger (or user) 1230 which receives the autonomous driving service, and the vehicle 1200, the server 1250, the docker 1260, the passenger 1230, and the management camera 1270 may be connected to a network 1290.

The vehicle 1200 and/or the docker 1260 of FIG. 12 may be configured to be substantially the same as the vehicle 10 described with reference to FIGS. 5 to 11. The server 1250 may provide information necessary for the drive of the vehicle 1200 or receive and store information related to the drive from the vehicle 1200 while communicating with the vehicle 1200.

In an embodiment of the present disclosure, the server 1250 may search for and select optimal autonomous vehicle 1200 and/or docker 1260 according to the request of the passenger 1230, and the vehicle 1200 may request the drive information necessary along a set drive path to the server 1250.

In addition, in an embodiment of the present disclosure, the docker 1260 may provide the docking service according to the embodiment of the present disclosure to the passenger 1230. For example, the docker 1260 may be the ultra-lightweight autonomous drive robot and may provide the docking service to the passenger 1230 having the baggage 1240. For example, the passenger 1230 having the baggage 1240 may receive the docking service by calling the vehicle 1200 (for example, an Uber taxi or a shared vehicle) and simultaneously calling the docker 1260.

In an embodiment, when the passenger 1230 requests the call of the docker 1260, a docker platform (or docker platform server) can an optimal docker based on size/weight of the baggage 1240, a location of the vehicle 1200, a drive path, or the like. The docker 1260 selected by the docker platform may approach the vehicle 1200 and provide the docker service. For example, the docker 1260 (or docker platform) may scan the size/weight of the baggage 1240 and transmit related information thereof to the docker platform or server 1250, and the docker platform can select the optimal docker based on the related information. As another example, the management camera 1270 installed at a stop may detect the size or the like of the baggage 1240 and transmit related information thereof to the docker platform or the server 1250. The management camera 1270 may be an artificial intelligence CCTV. The docking service providing method using the docker 1260 will be described in detail later.

Here, communication between the vehicle 1200 and the server 1250 or the docker 1260 may be used. For example, the network infrastructure and signal transmission and reception procedures described with reference to FIGS. 1 to 4 may be applied to the communication between the vehicle 1200 and the server 1250 or the communication between the vehicle 1200 and the docker 1260.

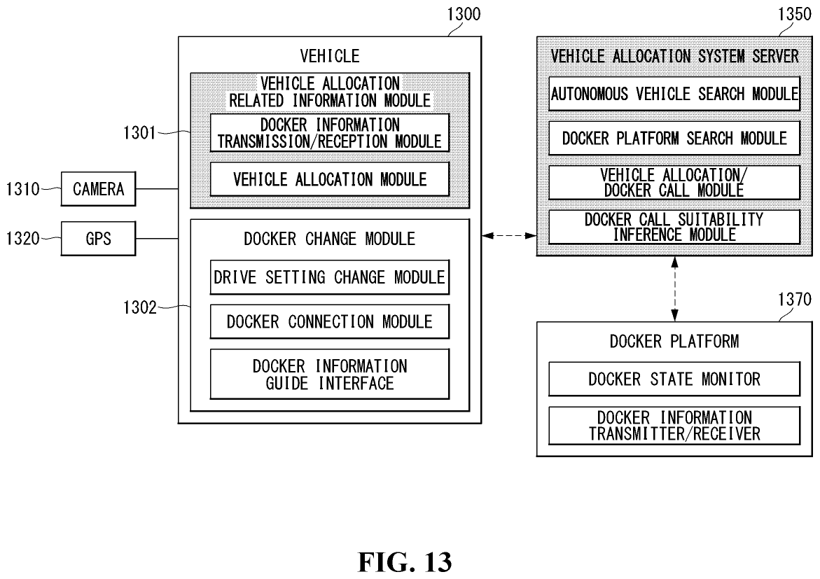

FIG. 13 shows an example of a block diagram of an autonomous driving system according to an embodiment of the present disclosure.

A vehicle 1300 of FIG. 13 shows an example of the device configured in the vehicle 1200 for controlling the vehicle 1200 of FIG. 12, and a server 1350 of FIG. 13 shows an example of the device configured in the server 1250 of FIG. 12. The vehicle 1300 of FIG. 13 may be configured as a portion of the autonomous device 260 described with reference to FIG. 5. Each configuration shown in FIG. 13 may provide/perform the docking service according to an embodiment described later.

Referring to FIG. 13, the vehicle 1300 may include a vehicle allocation related information module 1301 and a docker change module 1302. The vehicle 1300 may be functionally connected to a camera 1310 and a GPS 1320. In FIG. 13, the camera 1310 and the GPS 1320 are configured to be separated from the vehicle 1300. However, the present disclosure is not limited thereto and may be implemented in a configuration in which the camera 1310 and the GPS 1320 are included in the vehicle 1300. The vehicle allocation related information module 1301 and the docker change module 1302 may be functionally connected with a processor and/or memory of the vehicle 1300. In addition, the vehicle allocation related information module 1301 and the docker change module 1302 may be functionally connected to each other.

The vehicle allocation related information module 1301 may include a docker information transmission/reception module and a vehicle allocation module. In an embodiment, the docker information transmission/reception module may perform wired/wireless communication with the vehicle allocation system server 1350, and may transmit and receive docker information through the wired/wireless communication. The vehicle allocation module may perform wired/wireless communication with the vehicle allocation system server 1350, and may transmit or receive allocation information, destination information, drive path information, or the like of the vehicle through the wired/wireless communication.

The docker change module 1302 may include a drive setting change module, a docker connection module, and a docker information guide interface. In an embodiment, the drive setting changing module may change the drive setting of the vehicle 1300 according to the connection with the docker. The docker connection module may perform an operation for performing a physical connection with the docker. The docker information guide interface may guide the docker information through the interface of the vehicle 1300.

The vehicle allocation system server 1350 may communicate with the vehicle 1300. In an embodiment, the network infrastructure and signal transmission and reception procedures described with reference to FIGS. 1 to 4 may be applied. The vehicle allocation system server 1350 may include an autonomous vehicle search module, a docker platform search module, an allocation/docker call module, and a docker call suitability inference module. In an embodiment, the autonomous vehicle search module may search for the optimal autonomous vehicle according to a calling location (or allocation location) of the passenger. The docker platform search module may search for the docker platform to call the docker according to the calling location (or vehicle allocation location) of the passenger. The allocation/docker call module may call the searched autonomous vehicle and/or docker. The docker call suitability inference module may infer whether or not the docker call is appropriate based on the location of the docker or the location of the docker platform.

The docker platform 1370 may communicate with the vehicle allocation system server 1350. In an embodiment, the network infrastructure and signal transmission and reception procedures described with reference to FIGS. 1 to 4 may be applied. The docker platform 1370 may include a docker state monitor and a docker information transmitter/receiver. In an embodiment, the docker state monitor may monitor with respect to the states of the dockers or an individual state of the docker in the docker platform. The docker information transmitter/receiver may communicate with the vehicle allocation system server 1350 for list information of the currently available dockers and specification/function/option information of the docker.

The configurations of the vehicle 1300, the vehicle allocation system server 1350, and the docker platform 1370 shown in FIG. 13 are merely examples, and various configurations for controlling the vehicle may be additionally included or at least some of the configurations shown in FIG. 13 may be omitted or replaced.

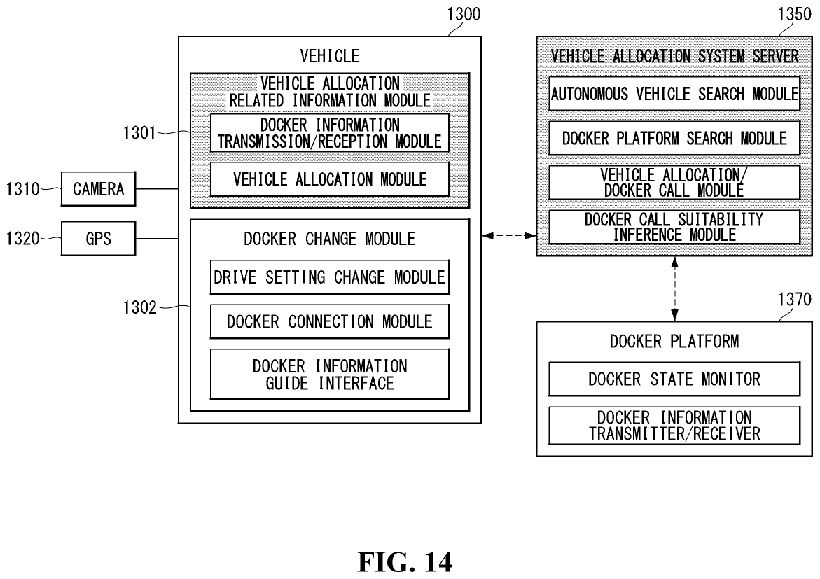

FIG. 14 shows an example of a block diagram of an autonomous driving system according to an embodiment of the present disclosure.

A vehicle 1400 of FIG. 14 shows an example of a device configured in the vehicle 1200 to control the vehicle 1200 of FIG. 12. The vehicle 1400 of FIG. 14 may be configured as portion of the autonomous device 260 described with reference to FIG. 5. Each component shown in FIG. 14 may provide/perform a docking service according to an embodiment to be described later.

Referring to FIG. 14, the vehicle 1400 may include a vehicle allocation related information module 1401 and a docker change module 1402. The vehicle 1400 may be functionally connected to a camera 1410 and a GPS 1420. In FIG. 14, the camera 1410 and the GPS 1420 are configured to be separated from the vehicle 1400. However, the present disclosure is not limited thereto and may be implemented in a configuration in which the camera 1410 and the GPS 1420 are included in the vehicle 1400. The vehicle allocation related information module 1401 and the docker change module 1402 may be functionally connected with a processor and/or a memory of the vehicle 1400. In addition, the vehicle allocation related information module 1401 and the docker change module 1402 may be functionally connected to each other.

The vehicle allocation related information module 1401 may include a docker information transmission/reception module and a vehicle allocation module. In an embodiment, the docker information transmission/reception module may perform wired/wireless communication with the vehicle allocation system server, and may transmit and receive docker information through the wired/wireless communication. The vehicle allocation module may perform wired/wireless communication with the vehicle allocation system server, and may transmit or receive allocation information, destination information, drive path information, or the like of the vehicle through the wired/wireless communication.

The docker change module 1402 may include a drive setting change module, a docker connection module, and a docker information guide interface. In an embodiment, the drive setting changing module may perform wired/wireless communication with a drive setting change module 1460 and may change the drive setting of the vehicle 1400 according to the connection with the docker 1460. The docker connection module may performs wired/wireless communication with the docker 1460 and may perform an operation for performing a physical connection with the docker 1460. The docker information guide interface may guide the docker information through the interface of the vehicle 1400.

The docker 1460 may communicate with the vehicle 1400. In an embodiment, the network infrastructure and signal transmission and reception procedures described with reference to FIGS. 1 to 4 may be applied. The docker may include a docker drive transmission/reception module and a docker monitoring module. In an embodiment, the docker drive transmission/reception module may transmit/receive drive related information of the docker 1460 with the vehicle 1400 and/or server. The docker monitoring module may monitor internal/external state or the like of the docker 1460.

The docker platform 1470 may communicate with the vehicle allocation system server 1450. The docker platform 1470 may be referred to as a docker platform server, a docker server, or the like. In an embodiment, the network infrastructure and signal transmission and reception procedures described with reference to FIGS. 1 to 4 may be applied. The docker platform 1470 may include a docker state monitor and a docker information transmitter/receiver. In an embodiment, the docker state monitor may monitor with respect to the states of the dockers or an individual state of the docker in the docker platform. The docker information transmitter/receiver may communicate with the vehicle allocation system server 1450 for list information of the currently available dockers and specification/function/option information of the docker.

The configurations of the vehicle 1400, the vehicle allocation system server 1450, and the docker platform 1470 shown in FIG. 14 are merely examples, and various configurations for controlling the vehicle may be additionally included or at least some of the configurations shown in FIG. 14 may be omitted or replaced.

Hereinafter, the docking service in the autonomous driving system will be described in detail.

Docker (Example: Docker 1460 in FIG. 14)

In an embodiment of the present disclosure, the docker may be referred to as the ultra-lightweight autonomous driving robot. The docker may be physically coupled to the calling autonomous vehicle and transport the baggage of the passenger.

In various embodiments, the docker may have the following functions.
Driving function: the docker is a battery rechargeable docker and can drive to the input destination at the shortest distance. In an embodiment, a drive available distance is proportional to battery charge, but the docker may be limited to a drive over a preset distance (for example, up to 5 km). In this case, the preset distance may be determined to be an area which is to be charged by the autonomous vehicle.
Baggage monitoring function: the docker may include at least one or more of sensors and/or ultra-lightweight cameras to guide the state information of the baggage to the passenger. In an embodiment, in a case of a monitoring device (or instrument), there may be a docker equipped with a relatively high specification sensor/camera, and a call to the docker may be possible according to a need or request of the passenger. In addition, a call cost of the docker may vary depending on the high specification monitoring device added.
Vehicle communication function: the docker can communicate with the autonomous vehicle and/or server. In an embodiment, when coupled to the vehicle, information (for example, size/baggage information) of the docker may be transmitted to the vehicle. In addition, during the drive, the baggage information of the docker may be transmitted to the vehicle and/or passenger (or passenger device) in real time.

In an embodiment of the present disclosure, there may be a regionally based platform (station) for the docker, and the docker may perform the charging and/or may standby at the platform. The platform may include a platform server which controls the operation of the platform. A size and shape of the docker may be provided in various forms. When the docker is coupled to the vehicle (for example, the vehicle 1200 of FIG. 12), the docker may be changed to a state where the autonomous driving is not necessary. For example, the docker is automatically attached/connected to a rear of the vehicle, and thus, may be changed to a state where the autonomous driving is not necessary after the connection.

In an embodiment, the vehicle and the docker may be connected to each other by a tow ring system. The tow ring system may be attached to a vehicle. Here, the tow ring system is a device for physically coupling the vehicle, and may include a network connector for communication with the vehicle.

Docker Call Method

In an embodiment of the present disclosure, the passenger may request a docker according to a baggage state. For example, when the passenger (or passenger device) calls a vehicle, the passenger can call the vehicle by selecting a docker addition option and transmitting the relevant information if there is the baggage.

A server (may be referred to as or vehicle allocation server, vehicle allocation system server, or the like) which receives a vehicle call message (or information or signal) including docker request information may search for the autonomous vehicle and search for the docker platform.

In the present disclosure, the docker platform (docker stop) may represent a platform or other servers managing the docker (or docking service). For example, the docker platform may be referred to as a docker platform server, a docker stop server, a docker server, a docking platform server, a docking stop server, or the like, and the docker platform may be implemented as the vehicle allocation management server and one server.

In an embodiment of the present disclosure, the server may search for the autonomous vehicle based on various searching conditions. For example, the server may search for the autonomous vehicle based on at least one of whether or not communication with the docker is possible, a distance from a call location (or vehicle allocation location), and a vehicle allocation state. As an example, the autonomous vehicle may be searched/selected among idle vehicles by the server. In addition, as an example, at the time of the searching/selecting of the autonomous vehicle, the server may check whether or not a connection ring system is provided (for example, whether or not the vehicle can be physically connected/network-connected to the docker).

In addition, the server may search for the docker platform based on various searching conditions. For example, the server may search for the docker platform based on at least one of the docker platform near to the call location, and the docker information or call information available in each docker platform.

In an embodiment, a search order of the docker platform may be determined as follows.

In a first step, the server transmits a docker call request to the docker platform adjacent to the call location. That is, the server may search for the docker platform in a 1:N manner. In the second step, the docker platform acquires state information of the docker which is parked in each docker platform. For example, the state information of the docker may include at least one of a charging state, a size, specification information of a monitoring device (or a tool), or a reservation state. The callable state of the docker may be defined as an autonomous drivable charging and/or no pre-reservation state to the calling location. In a third step, the docker platform transmits a list of available dockers to the server. For example, docker list information may include docker platform information, a charging state of the docker, the size, the monitoring device, or the like.

In an embodiment, when the docker is called from the vehicle being driven, a near location in which parking or stopping is possible may be determined (or be set) as a call location. In this case, the server may replace the vehicle currently being boarded with the autonomous vehicle without searching for the autonomous vehicle as described above.

In addition, in an embodiment, when the searched docker platform does not exist, the server may search for a point at which calling of the docker is possible on the drive path to the destination requested by a caller. In addition, the server may perform (or query) a reservation for a corresponding docker of the searchable callable point. For example, the server may reserve the docker or cancel use of the docker according to the response of the caller (or passenger).

In addition, the server may infer (or search for) a docker platform having a similar time to the call location of the autonomous vehicle searched through the above-described autonomous vehicle searching. As an embodiment, call suitability may be defined as similarity between a time required from the docker platform to the call location and a time required from the autonomous vehicle to the call location. For example, assuming that the autonomous vehicle takes 10 minutes to the call location, when a first docker platform takes 20 minutes and a second docker platform consumes 10 minutes, the server selects the second docker platform as a suitable docker platform.

Moreover, in an embodiment, the server may inform the caller of the information of the autonomous vehicle allocated to the caller and the docker information available on the inferred docker platform. Here, the autonomous vehicle information may include vehicle information, an arrival time to the call location, or the like. The docker information may include a docker location, docker platform information, docker state information, a time required to call location of the docker, or the like.

In addition, the caller receiving the docker information may select the required docker according to the size/type of the baggage and request a call of the selected docker to the server. For example, when the docker is called, docker call information may be transmitted to a server. Here, the call information may include caller information (for example, personal information of caller, destination information, call location, or the like), autonomous vehicle information (for example, vehicle information, exchangeable data, communication scheme) to be connected, or the like.

Connection Between Vehicle and Docker

In an embodiment of the present disclosure, the docker may search for a reserved connection vehicle and perform a connection procedure when the docker is adjacent to a call location (or designated location). In this case, the docker may search for the reserved connection vehicle through a V2X communication method.

Specifically, when the docker arrives behind the autonomous vehicle, a connection process may be performed to couple the vehicle and the docker to each other.

First, when the docker is close to the autonomous vehicle, the docker may perform authentication for the autonomous vehicle. For example, the docker may authenticate the autonomous vehicle based on the information received from the server. For example, the information required for authentication may include autonomous vehicle information, caller (or passenger) information, docker information, or the like.

Thereafter, the vehicle can change drive related setting in consideration of the coupling to the docker. In an embodiment, the vehicle may receive the size information of the docker to change a drive setting value. For example, the drive setting value may include information such as a steering angle at the time of curve, a speed limit before and after a bump, controls of other vehicles according to the traffic signal, or the like. Moreover, for example, a vehicle control according to the traffic signal indicate a vehicle control/setting change in consideration of a change of a time to pass through an intersection or other road features according to the total length of the vehicle as the docker is added (or mounted).

In addition, the vehicle may add communication network information in consideration of the coupling to the docker, or may reflect the communication network information to set the vehicle. For example, the communication network information may include the docker information (for example, size or specification of decker) or speed limit information according to the addition of the docker. As an example, in adjustment of an interval between vehicles, the size information of the docker may be used, or when the vehicle overtakes other vehicles, overtaking (or overtaking speed) may be determined according to the docker information of the corresponding vehicle. Thereafter, the vehicle may perform a physical coupling to the docker. In this case, for example, the physical coupling may be performed by a magnetic coupling or a ring coupling.

In an embodiment, after the vehicle and the docker are physically coupled to each other, a pre-authenticated caller may load the baggage into the docker. If the drive is started after the physical coupling, the vehicle can start the drive with the changed drive setting value. Once the drive is completed, the physical coupling of the docker coupled to the vehicle is released, and the docker can be returned to the nearest platform via the autonomous driving.

Monitoring Method of Docker During Driving

In an embodiment of the present disclosure, a docker connected to the autonomous vehicle may monitor the internal/external baggage state and inform the vehicle and/or passenger of the state information.

In an embodiment, the docker connected to the autonomous vehicle may classify a current safety state of the baggage. That is, the docker may obtain the internal/external monitoring information. For example, the internal monitoring information may include location change tracking of the baggage in the docker, the baggage state in the docker, or the like. The docker may classify the internal state of the docker into a dangerous (or warning) state when a location change of the baggage in the docker according to a drive change is equal to or larger than a threshold, and/or when an object contained in the baggage is taken out due to the drive change and may notify the vehicle and/or passenger of the monitoring result.

In addition, the external monitoring information may include a degree of impact, shaking information of the docker, or the like. The docker may differently provide information to the passenger depending on the classified safety state. The docker classifies the external state of the docker into the dangerous (or warning) state when a shock value in the docker is equal to or larger than the threshold and/or when the shaking of the docker during the driving is detected above an average in a limited time, and may inform the vehicle and/or passenger of the monitoring result.

The docker may inform the vehicle and/or passenger of the state the docker during the driving. For example, it is possible to guide a change in the external monitoring information. The docker may provide a video service to a device of the vehicle and/or passenger to monitor the state of the baggage in the docker if necessary.

In an embodiment of the present disclosure, the docker may inform the vehicle and/or passenger of the state during the drive. For example, the docker may inform the change of the external monitoring information. For example, the docker may reproduce a baggage state image to check the state change of the baggage of the passenger in the docker. For example, in safety/attention step, the baggage of the current passenger is in a safety step, and the docker may receive a request of a video service for the state of the baggage or provide an image service. Alternatively, the docker may receive a request for a service on the state of baggage or provide the image service because an impact is detected during the external monitoring.

In addition, as an example, the docker may inform the change of the internal monitoring information. For example, the docker may provide parking/stopping service to directly check the baggage. If the location of the current baggage has changed by a predefined threshold or more (for example, 40% or more) relative to the existing location, the docker may inform that the baggage of the current passenger is in a warning step, reproduce the baggage state image, and transmit/display parking/stopping guidance message to directly check the baggage.

When the docker directly checks the baggage of the passenger and accepts the result in the above-described step, the docker may stop the vehicle in a near parking/stop area and inquire the passenger whether the baggage safety check is completed.

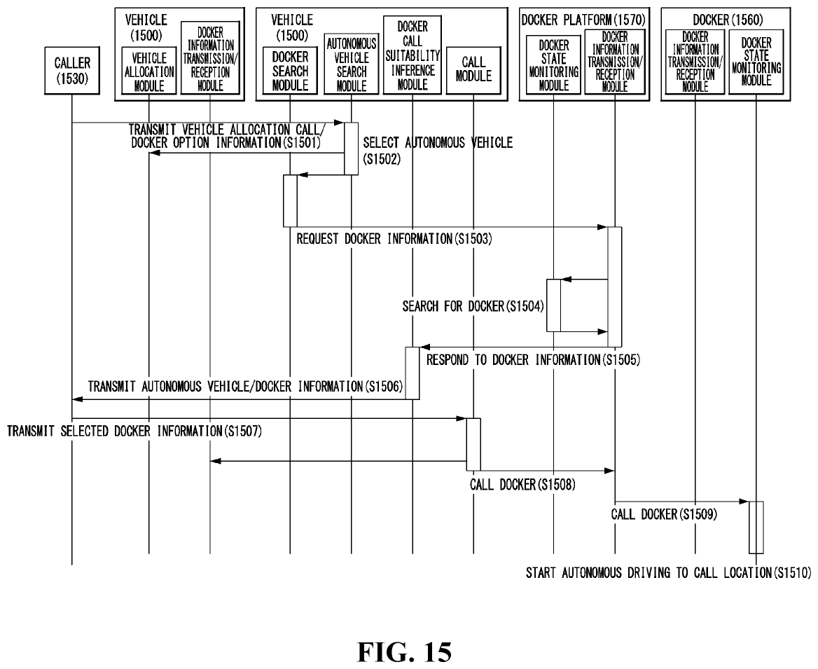

FIG. 15 is a signal flowchart showing an example of the docker call method according to an embodiment to which the present disclosure is applied.

Referring to FIG. 15, a caller 1530 may transmit the vehicle call message to a server 1500 (S1501).

For example, the vehicle call message may include a docker request. The docker request may transmit docker option information (for example, weight or size of baggage) prepared or selected by the caller 1530. As described above, the caller 1530 may be understood as a terminal (for example, portable device, smart phone, or the like) of the passenger who request the allocation of the vehicle.

The server 1550 may select a specific vehicle in response to the request.

In S1502, the server 1550 may transmit a call message including information or the like on the caller 1530 to the selected vehicle 1500.

When there is the docker request by the caller 1530, first, the server 1550 may transmit a docker information request message to receive the docker information from the docker platform to the docker platform (or docker platform server) in order to provide the docking service (S1503).

The docker platform 1570 may search for an available docker in response to the docker information request message received from the server 1550, and send the docker information response message including an available docker list and a docker information response message to the server 1550 (S1505).

The server 1550 may transmit the available docker list and docker platform information received from the docker platform 1570 to the caller 1530, and receive docker information selected from the caller 1530 (S1506 and S1507). In addition, the server 1550 may transmit a second docker call message calling the selected docker 1560 to the docker platform 1570, and the docker platform 1570 may transmit the second docker call message requesting provisions of the autonomous driving and the docking service to the selected docker 1560 (S1508, S1509).

The embodiment according to the flowchart of FIG. 15 is an example, and the present disclosure is not limited thereto. Some steps may be omitted from the steps shown in FIG. 15, and steps other than the steps shown in FIG. 15 may be added. In addition, the present embodiment may be applied in combination with embodiments regarding the above-described docker and the call method of the docker.

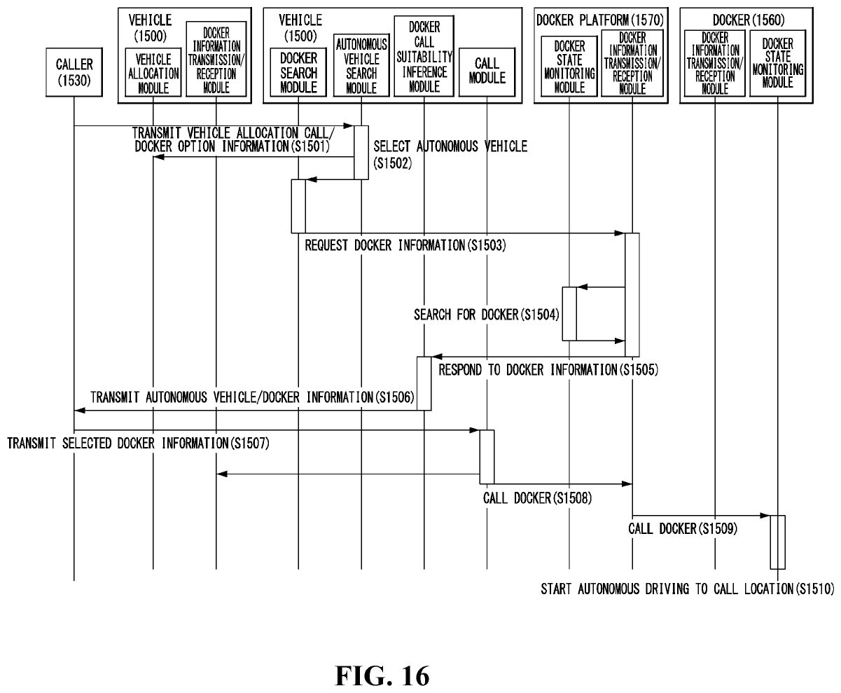

FIG. 16 is a signal flowchart showing an example of a connection method between the vehicle and the docker according to an embodiment to which the present disclosure is applied.

Referring to FIG. 16, a docker 1660 may search for a vehicle 1600 (S1601).

In this case, the docker may search for the reserved connection vehicle through the V2X communication method. When the vehicle 1600 is searched by the docker 1660, the vehicle 1600 may transmit a reserved vehicle response message indicating that the vehicle 1600 corresponds to the reserved vehicle to the docker 1600 (S1602).

The docker 1660 may transmit docker information including information necessary for connection between the docker 1660 and the vehicle 1600 to the vehicle 1600 (S1603).

For example, the docker information may include authentication information for the autonomous vehicle. The connection between the docker 1660 and the vehicle 1600 may be performed (S1604).

After the connection, the docker 1660 may start monitoring regarding the inside/outside of the docker 1600 (S1605). In this case, the embodiment regarding the docker monitoring method of the above-described driving will be applied. If the driving completion occurs, the docker 1660 may search for a near docker platform based on the location of the docker 1660 and may be returned to the searched docker platform.

The embodiment according to the procedure of FIG. 16 is an example, the present disclosure is not limited to this. That is, some steps may be omitted from the steps shown in FIG. 16, and steps other than the steps shown in FIG. 16 may be added. Moreover, the present embodiment may be applied in combination with embodiments regarding the above-described docker, the connection between the vehicle and the docker, and the docker monitoring method during the driving.

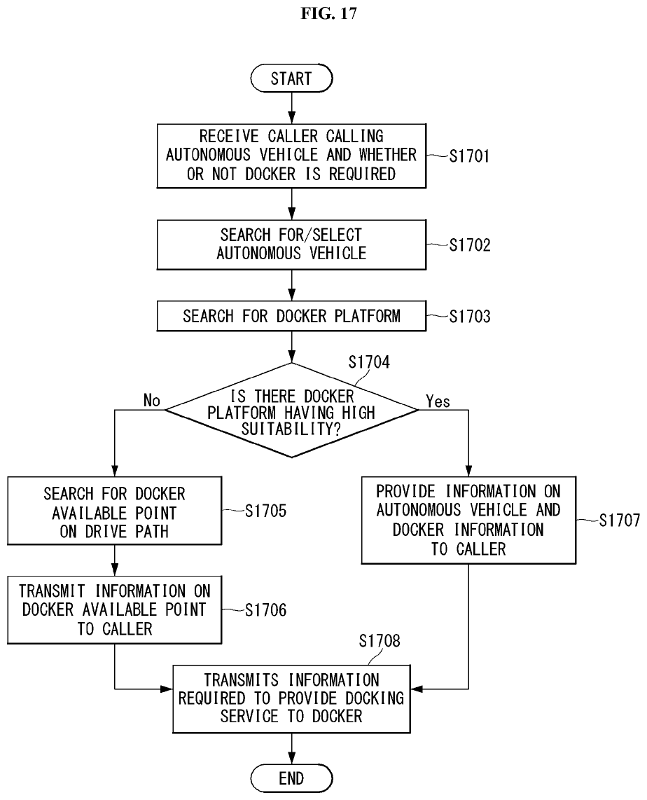

FIG. 17 is a flowchart showing an example of the docker call method according to an embodiment of the present disclosure.

Referring to FIG. 17, the server receives a vehicle call message including call information for an autonomous vehicle of the caller (passenger) (S1701). In this case, the vehicle call message may include information on whether or not the docker is needed based on the baggage state of the caller.

The server searches for/selects the autonomous vehicle (S1702). If there is the docker request, the server searches for the docker platform to provide a docking service (S1703). The server checks whether or not there is a docker platform having high suitability based on the call location of the caller and the location of the autonomous vehicle (S1704).

If there is no platform having high suitability, the server searches for a docker available point on the drive path and transmits information on the docker available point to the caller (S1705 and S1706). For example, the information transmitted to the caller may include location information of the docker available point, docker platform information, and docker list information.

If there is a platform having high suitability, the server transmits information on the autonomous vehicle and the docker information to the caller (S1707). For example, the docker information may include the docker platform information and the docker list information.

The server transmits information required to provide a docking service to the docker (S1708). The information necessary for providing the docking service may include drive information, location information, call location information, or the like of the autonomous vehicle.

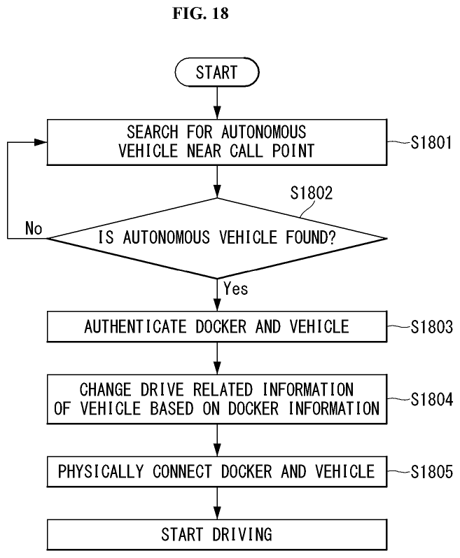

FIG. 18 is a signal flowchart showing an example of a connection method between an autonomous vehicle and a docker according to an embodiment of the present disclosure.

Referring to FIG. 18, the docker may search for an autonomous vehicle near a call point (S1801).

In this case, the docker may perform a search for the reserved connection vehicle through the V2X communication method. When the docker finds the autonomous vehicle, the docker may perform authentication on the autonomous vehicle (S1802, S1803). For example, the docker may authenticate the autonomous vehicle based on the information received from the server. For example, the information required for authentication may include autonomous vehicle information, the caller (or passenger), the docker information, or the like.

The docker may change the drive related information (or setting) of the vehicle (S1804).

In an embodiment, the vehicle may receive the size information of the docker to change the drive setting value. For example, the drive setting value may include information such as the steering angle at the time of curve, a speed limit before and after a bump, the controls of other vehicles according to the traffic signal, or the like. Moreover, for example, a vehicle control according to the traffic signal indicate a vehicle control/setting change in consideration of a change of a time to pass through an intersection or other road features according to the total length of the vehicle as the docker is added (or mounted).

In addition, the vehicle may add communication network information in consideration of the coupling to the docker, or may reflect the communication network information to set the vehicle. For example, the communication network information may include the docker information (for example, size or specification of decker) or speed limit information according to the addition of the docker. As an example, in adjustment of an interval between vehicles, the size information of the docker may be used, or when the vehicle overtakes other vehicles, overtaking (or overtaking speed) may be determined according to the docker information of the corresponding vehicle. Thereafter, the vehicle may perform a physical coupling to the docker. In this case, for example, the physical coupling may be performed by a magnetic coupling or a ring coupling.

In an embodiment, after the vehicle and the docker are physically coupled to each other, a pre-authenticated caller may load the baggage into the docker. If the drive is started after the physical coupling, the vehicle can start the drive with the changed drive setting value. Once the drive is completed, the physical coupling of the docker coupled to the vehicle is released, and the docker can be returned to the nearest platform via the autonomous driving.

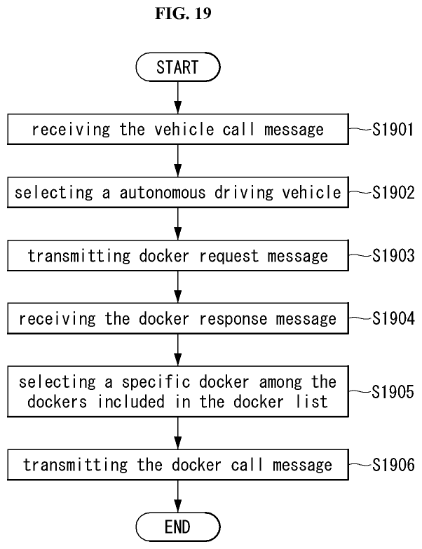

FIG. 19 is a flowchart showing an example of a method for controlling a vehicle in an autonomous driving system according to an embodiment of the present disclosure.

Referring to FIG. 19, the server receives the vehicle call message including information on whether to request the docker from the device of the passenger (S1901).

The server selects a vehicle based on first information indicating the call location of the passenger (S1902).

In response to the vehicle call message, the server transmits he docker request message including at least one of the first information, second information indicating the location of the vehicle, and third information indicating the drive path of the vehicle, to the docker platform. (S1903).

The server receives the docker response message including the available docker list from the docker platform (S1904).

The server selects a specific docker among the dockers included in the docker list (S1905).

The server transmits the docker call message requesting the provision of the docking service for the vehicle to the selected docker (S1906).

As described above, in Step S1902, the vehicle can be selected based on information indicating whether or not communication with the docker is possible, information indicating whether or not the physical connection with the docker is possible, distance information between the call location and the vehicle, or vehicle allocation state information of the vehicle.

As described above, Step S1903 may include selecting a docker platform based on the first information and docker request information of the passenger and transmitting the docker request message to the selected docker platform.

As described above, the docker list information includes information on at least one docker available in the docker platform, the information on the docker is the charging state information of the docker, the size information of the docker, and the monitoring device information provided in the docker.

As described above, the docker call message includes the authentication information on the vehicle, and when the selected docker approaches within a specific distance range based on the call location, the authentication between the vehicle and the docker may be performed based on the authentication information on the vehicle.

As described above, the vehicle may be provided with the monitoring information on the inside of the selected docker and/or the monitoring information on the outside of the selected docker by the selected docker.

As described above, the method may further include changing a drive setting value of the vehicle based on the size information of the selected docker.

As described above, changing the drive setting value of the vehicle may be performed by changing the vehicle interval setting value and the other vehicle overtaking speed setting value based on the size information of the selected docker.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

According to the embodiment of the present disclosure, it is possible to an optimum comfort to all passengers present in the vehicle by providing the docking service, and thus, to increase the drive satisfaction. In addition, it is possible to secure safety of the baggage to be transported.

Moreover, according to the embodiment of the present disclosure, a user convenience may be improved by calling a docker nearest to a baggage generation point of the passenger.

In addition, according to the embodiment of the present disclosure, it is possible to provide information satisfaction to the passenger through the baggage state monitoring.

Effects obtained in the present disclosure are not limited to the effects mentioned above, and other effects not mentioned can be clearly understood by a person skilled in the art from the above descriptions.

1. A method for controlling a docker by a server of a communication network, the method comprising:
receiving a vehicle call message from a device of a passenger, the vehicle call message including information regarding a docker request;
selecting a vehicle based on first information indicating a call location of the passenger;
transmitting a docker request message including at least one of the first information, second information indicating a location of the vehicle, and third information indicating a drive path of the vehicle to a docker platform in response to the vehicle call message;
receiving a docker response message including an available docker list from the docker platform;
selecting a docker among dockers included in the docker list; and
transmitting a docker call message requesting a provision of a docking service for the selected vehicle to the selected docker,
wherein the server communicates with the device of the passenger, the selected vehicle, the docker platform, and the selected docker in the communication network.

2. The method of claim 1, wherein the vehicle is selected based on:
information indicating whether or not communication with the docker is possible;
information indicating whether or not a physical connection to the docker is possible;
information on a distance between the call location and the vehicle; and
vehicle allocation state information of the vehicle.

3. The method of claim 1, wherein the transmitting the docker request message to the docker platform comprises:
selecting the docker platform based on the first information and docker request information received from the device of the passenger; and
transmitting the docker request message to the selected docker platform.

4. The method of claim 1, wherein:
the docker list information includes information on at least one docker available in the docker platform; and
the information on the at least one docker includes at least one of charging state information of the docker, size information of the docker, or monitoring device information provided in the docker.

5. The method of claim 1, wherein:
the docker call message includes authentication information on the vehicle; and
the authentication between the vehicle and the docker is performed based on the authentication information when the selected docker approaches within a specific distance range based on the call location.

6. The method of claim 1, wherein the selected docker provides at least one of monitoring information on inside of the selected docker or monitoring information on outside of the selected docker to the selected vehicle.

7. The method of claim 1, further comprising changing a drive setting value of the selected vehicle based on size information of the selected docker.

8. The method of claim 7, wherein the changing the drive setting value of the selected vehicle comprises changing a vehicle interval setting value and other vehicle overtaking speed setting value based on the size information of the selected docker.

9. An apparatus for controlling a docker, the apparatus comprising:
a processor configured to control a vehicle;
a memory coupled to the processor and configured to store data for controlling the vehicle; and
a transceiver coupled to the processor and configured to transmit or receive data for controlling the vehicle,
wherein the processor is further configured to:
receive, via the transceiver a vehicle call message including information on regarding a docker request from a device of a passenger;
selects a vehicle based on first information indicating a call location of the passenger;
transmit, via the transceiver, a docker request message including at least one of the first information, second information indicating a location of the vehicle, and third information indicating a drive path of the vehicle to a docker platform in response to the vehicle call message;
receive, via the transceiver a docker response message including an available docker list from the docker platform;
select a docker among dockers included in the docker list; and
transmits a docker call message requesting a provision of a docking service for the selected vehicle to the selected docker,
wherein the apparatus communicates, via the transceiver, with the device of the passenger, the selected vehicle, the docker platform, and the selected docker in a communication network.

10. The apparatus of claim 9, wherein the processor is further configured to select the vehicle based on:
information indicating whether or not communication with the docker is possible;
information indicating whether or not a physical connection to the docker is possible;
information on a distance between the call location and the vehicle; and
vehicle allocation state information of the vehicle.

11. The apparatus of claim 9, wherein the processor is further configured to:
selects the docker platform based on the first information and docker request information received from the device of the passenger; and
transmit, via the transceiver, the docker request message to the selected docker platform.

12. The apparatus of claim 9, wherein:
the docker list information includes information on at least one docker available in the docker platform; and
the information on the at least one docker includes at least one of charging state information of the docker, size information of the docker, or monitoring device information provided in the docker.

13. The apparatus of claim 9, wherein:
the docker call message includes authentication information on the vehicle; and
authentication between the vehicle and the docker is performed based on the authentication information when the selected docker approaches within a specific distance range based on the call location.

14. The apparatus of claim 9, wherein the selected docker provides at least one of monitoring information on inside of the selected docker or monitoring information on outside of the selected docker to the selected vehicle.

15. The apparatus of claim 9, wherein the processor is further configured to change a drive setting value of the selected vehicle based on size information of the selected docker.

16. The apparatus of claim 15, wherein the processor is further configured to change a vehicle interval setting value and other vehicle overtaking speed setting value based on the size information of the selected docker.

17. The apparatus of claim 11, wherein the communication network comprises a 5G network.

18. The apparatus of claim 11, wherein the docker and the vehicle belong to an autonomous driving system and the vehicle is an autonomous vehicle.

19. The method of claim 1, wherein the communication network comprises a 5G network.

20. The method of claim 1, wherein the docker and the vehicle belong to an autonomous driving system and the vehicle is an autonomous vehicle.
